(19) United States
(12) Patent Application Publication
(10) Pub. No.: US 2009/0125358 A1
(43) Pub. Date: May 14, 2009

(54) Integrated Appointment Scheduling And Targeted Advertising

(76) Inventor: Michael Reynard, Santa Monica, CA (US)

Correspondence Address: Ashok Tanka;Of Counsel, Lipton, Weinberger & Husick, 36 Greenleigh Drive, Sewell, NJ, 08080, US

(21) Appl. No.: 12/020,606

(22) Filed: Jan. 28, 2008

Related U.S. Application Data
(60) Provisional application No. 60/986,895, filed on Nov. 9, 2007.

(51) Int. Cl. G06Q 30/00; G06Q 10/00

(52) U.S. Cl. 705/8; 705/14

(57) ABSTRACT

Disclosed herein is a computer implemented method and system for integrated appointment scheduling and targeted advertising. A host website provides an appointment scheduling application for scheduling an appointment. A user searches for a service provider on the host website to make an appointment. The user makes the appointment with the selected service provider on the host website or through multiple communication devices. The appointment scheduling application translates the appointment from the communication devices by integrating the appointment made on the host website and the appointment made through the communication devices in an appointment calendar on the host website. The appointment scheduling application schedules the appointment of the user with the selected service provider. The user is notified with a confirmation message and appointment reminder messages upon scheduling of the appointment. The method and system disclosed herein further inserts targeted advertisements with the confirmation messages, appointment reminder messages, and electronic newsletters.

### CROSS REFERENCE TO RELATED APPLICATIONS

This application claims the benefit of the provisional patent application number U.S. 60/986,895 titled “Internet-based Method and System for Integrating Appointment Scheduling with Targeted Advertising”, filed on Nov. 9, 2007 in the United States Patent and Trademark Office (U.S. PTO).

### BACKGROUND

This invention, in general, relates to appointment scheduling. More particularly, this invention relates to integrated appointment scheduling and targeted advertising.

Appointments are typically made through a telephone or manually over the counter. Booking an appointment over the counter may require customers to wait in a queue for a long time. Customers may also book appointments using appointment scheduling software. However, the cost and maintenance of the appointment scheduling software may not be economical to the providers of products and services known as service providers. Moreover, service providers may lack resources and expertise required to operate the appointment scheduling software.

Customers may also schedule appointments over the internet. However, current online appointment systems are not able to seamlessly integrate appointments added to an appointment calendar by telephone or other verbal communication. Moreover, customers may have difficulty in finding a required service provider over the internet.

Advertising is effective when targeting an audience most likely to be receptive to an advertiser's products or services. Customers prefer to view advertisements related to products or services of interest to the customer. Advertisers may therefore desire to disseminate information about their products or services to a targeted group of customers. However, obtaining demographic information from potential customers for targeted advertising may be a cumbersome and arduous task for the advertisers.

Hence, there is a need for a computer implemented method and system to schedule an appointment, integrate appointments added to an appointment calendar by multiple communication devices, and target advertisements based on automatically generated demographic information of the customer.

### SUMMARY OF THE INVENTION

The computer implemented method and system disclosed herein addresses the above stated needs for scheduling an appointment, integrating appointments added to an appointment calendar by multiple communication devices, and targeting advertisements based on automatically generated demographic information of a user.

The method and system disclosed herein provides an appointment scheduling application on a host website for scheduling an appointment. The host website enables customers herein referred to as “users”, providers of products and services herein referred to as “service providers”, and advertisers to enroll on the host website. The host website enables the user to search for a service provider from a list of service providers enrolled on the host website and make an appointment with a selected service provider.

The user may make the appointment through the host website or through multiple communication devices. The appointment scheduling application translates the appointment from the communication devices. The translation of the appointment from the communication devices includes integrating the appointment made on the host website and the appointment made through the communication devices in an appointment calendar on the host website.

The appointment scheduling application then schedules the appointment of the user with the selected service provider. The user is notified with a confirmation message upon scheduling of the appointment. Further, the user is notified with the confirmation message and appointment reminder messages by electronic mail, fax, telephone, a text message, a voice message, or a combination thereof. The method and system disclosed herein further inserts targeted advertisements in the confirmation message. The advertisers provide targeted advertisements on the host website. The targeted advertisements may be provided to the user and the service providers. The targeted advertisements include banner advertisements, pop up advertisements, or contextual advertisements. Moreover, the targeted advertisements may be inserted in the appointment reminder messages and electronic newsletters sent to the user and the service providers. The host website further includes links to the targeted advertisements, links for procurement of products or services, and links to external websites.

The method and system disclosed herein further generates reports based on demographic information and information of usage of the host website by the user and the service providers. The information included in the generated reports enables the advertisers to evaluate advertising strategies to enhance effectiveness of the advertising strategies.

The method and system disclosed herein enables service providers to schedule appointments with users and disseminate electronic documents including catalogs, electronic newsletters, laboratory results, and other forms of electronic communication to users who chose appointments with the service providers. The host website further allows advertisers to market their products or services through the appointment scheduling application. The host website allows advertisers to disseminate information about products and services to a selected group or groups of users. The advertisers may also target a group of users seeking an appointment with a specific service provider or group of service providers.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of integrated scheduling of an appointment and targeted advertising.

FIG. 2 illustrates a computer implemented system for integrated scheduling of an appointment and targeted advertising.

FIG. 3 exemplarily illustrates a flow chart depicting integrated appointment scheduling and targeted advertising.

FIG. 4 exemplarily illustrates an appointment calendar on the host website.

FIG. 5 exemplarily illustrates editing of an advertisement on the host website.

FIGS. 6A-6B exemplarily illustrate a report generated by the host website.

### DETAILED DESCRIPTION OF THE INVENTION

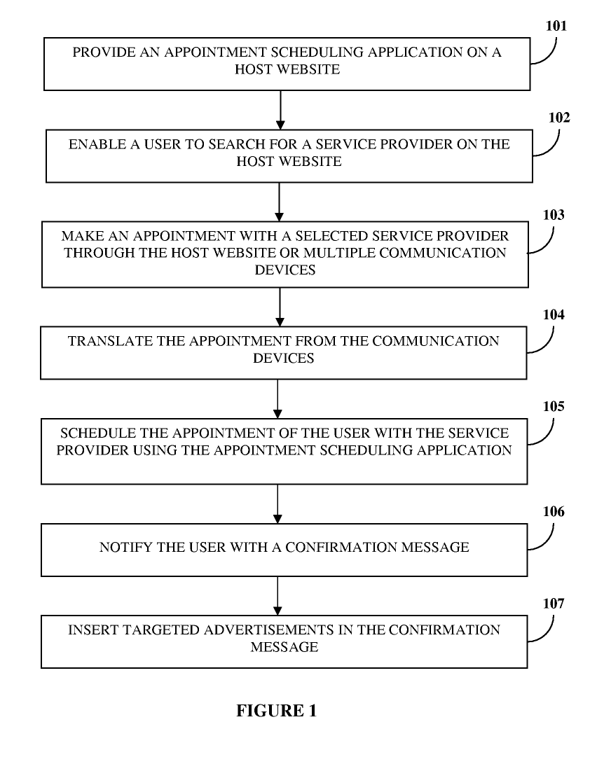

FIG. 1 illustrates a computer implemented method of integrated scheduling of an appointment and targeted advertising. The method disclosed herein provides 101 an appointment scheduling application on a host website for scheduling an appointment. The host website enables a customer, a client, or a patient herein referred to as a “user”, to enroll on the host website. The host website further enables providers of products and services herein referred to as “service providers”, and advertisers 203 to enroll on the host website. The user 201, the service providers 202, and the advertisers 203 create accounts on the host website in order to enroll on the host website. The user 201 may be a patient, a business client, a consumer of goods and services, etc. The service providers 202 may be medical service providers, business consultants, education service providers, hospitality service providers, transportation service providers, accountants, attorneys, etc.

The enrollment may be performed automatically on the host website or through an authorized individual on the host website. During the enrollment process, the host website requests for information from the user 201 and the service providers 202. The information may include, for example, name, mailing address, electronic mail (email) address, phone number, services provided, etc. The host website also collects demographic information such as gender, address, occupation, lifestyle, and education from the user 201 and the service providers 202. The collected information may be used for generating reports and for market research.

The advertisers 203 are also requested to provide information such as name, payment address, email address, business address, and material used for advertising. The authorized individual may review the information provided by the user 201, the service providers 202, and the advertisers 203. The authorized individual may enroll eligible users, service providers 202, and advertisers 203 on the host website. The authorized individual may disqualify the user 201 in case of misrepresentation, fraud, or illegal intent in the use of the host web site. Further, the authorized individual may disqualify service providers 202 or advertisers 203 conducting illegal or unlicensed businesses. The host website then confirms enrollment of the user 201, the service providers 202, and the advertisers 203 through an automated electronic confirmation.

As will be appreciated by those skilled in the art, other forms of enrollment processing may be applied, including, but not limited to, telephone, text messaging, regular mail, and email. In addition, although the automated enrollment function is preferably handled by the same computer system that handles the host web site, the automated enrollment function may be performed by dedicated, physically distinct computer systems or internet sites.

The host website enables 102 the user 201 to search for a service provider on the host website. The user 201 may select a service provider from a list of service providers 202 displayed on the host website. The service providers 202 may be categorized based on the type of products or services provided by the service providers 202. The user 201 may also conduct a category search and then select a service provider from the list of service providers 202 in the selected category.

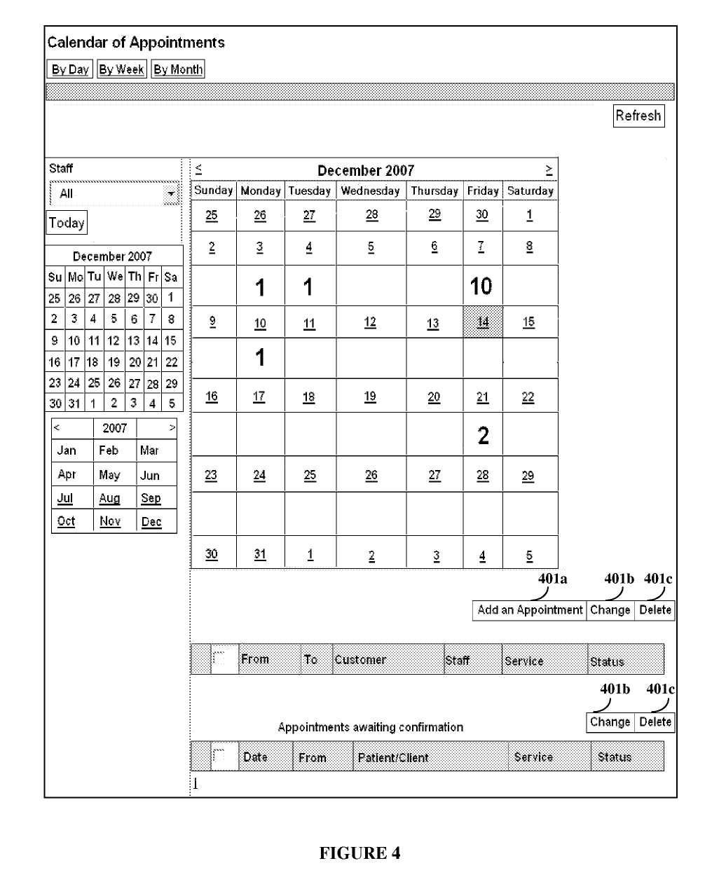

On selecting the service provider, the user 201 is directed to the service provider's appointment calendar. The user 201 may make 103 an appointment with the service provider. The user 201 may make the appointment through the host website or through multiple communication devices. The communication devices may include a fax, a pager, a personal digital assistant (PDA), or a telephone. The appointment scheduling application translates 104 the appointment from the communication devices. The translation of the appointment from the communication devices includes integrating the appointment made on the host website and the appointment made through the communication devices in the appointment calendar on the host website. For example, the appointment calendar may integrate appointments made online with the appointments made by manual input. The host website therefore allows an authorized individual to manually input appointments made by telephone, fax, etc. into the appointment calendar. The appointment calendar may also be synchronized with a digital calendar on the user's 201 PDA. The appointment calendar is exemplarily illustrated in FIG. 4.

The appointment calendar of the service provider may be individually controlled and customized to enable the service provider to select or deselect the service provider's availability based on desires and needs. The service provider may also offer the users choices of a variety of products and services under a registered category on the host website. For example, an ophthalmologist may offer an appointment for a lasik consultation on Mondays for sixty minutes and an appointment for a regular eye examination for fifty minutes on other business days of the week.

The appointment scheduling application then schedules 105 the appointment of the user 201 with a selected service provider. The appointment may be scheduled on the host website at any time of the day or night. The host website provides the user 201 and the service providers 202 a facility to modify the scheduled appointment. The appointment scheduling application notifies 106 the user 201 with an appointment confirmation in the form of a confirmation message upon scheduling of the appointment. Further, the appointment scheduling application notifies the user 201 and the service provider of appointment reminders in the form of appointment reminder messages. The appointment reminders may be generated at different time intervals selected by the user 201 and the service providers 202.

The appointment confirmation and the appointment reminders may be generated in different formats determined by the user 201 and the service provider. The confirmation message and the appointment reminder messages may be sent to the user 201 by email, fax, telephone, a text message, a voice message, or a combination thereof, in a language predetermined by the user 201. For example, the user 201 may receive the confirmation message and the appointment reminder messages in English, French, Spanish, etc. The host website enables the user 201 and the service providers 202 to modify the sequence of appointment confirmations or appointment reminders. For example, a user 201 who chooses an email appointment reminder may access the host website at a later visit and change preference to receiving an appointment reminder by fax.

The method disclosed herein inserts 107 targeted advertisements in the confirmation message and the appointment reminder messages. For example, female patients making an appointment with a dermatologist may receive an advertisement for Botox™ when receiving their appointment confirmation or appointment reminder. The advertisers 203 provide the targeted advertisements on the host website. The targeted advertisements may be provided to the user 201 or the service providers 202. The targeted advertisements include banner advertisements, pop up advertisements, contextual advertisements, etc. Exemplarily, the banner advertisements may be displayed with the appointment calendar when the user 201 chooses to make an appointment on the host website. In addition, non-obtrusive pop up advertisements at intervals selected by the authorized individual may be displayed during appointment scheduling. The advertisements may be targeted to the user 201 and the service providers 202 through one of an email attachment, fax, telephone, a text message, a voice message, or a combination thereof.

The advertisers 203 may target advertisements to a group of users or to a group of service providers 202 based on the demographic information provided on the host website. For example, a pharmaceutical firm may advertise a medication to a group of physicians. The host website categorizes the users based on their demographic information and their selection of the service providers 202. The advertisements provided by the advertisers 203 are then matched with demographic information and selection of the service providers 202 and targeted to the relevant users and service providers 202. For example, male users seeking an appointment with a urologist or a sex counselor may be presented with an advertisement related to Viagra™. Users who have further interest in Viagra™ may click on the Viagra™ advertisement displayed on the host website and be hyperlinked to a descriptive page, a discount coupon, an order page, or another internet website comprising additional information regarding Viagra™ or related products. In another example, users who chose a service provider belonging to the category of “financial planner,” may be presented with an advertisement for a book on retirement planning.

The advertisements may be in the contextual format of the accompanying appointment confirmation or appointment reminders. For example, an appointment confirmation made by telephone communication may be accompanied by a telephonic advertisement; an appointment reminder sent by fax communication may be accompanied by a fax advertisement. Moreover, the advertisements accompanying email transmissions for the appointment confirmation or the appointment reminders may be hyperlinked to a procurement system for acquisition of products or services.

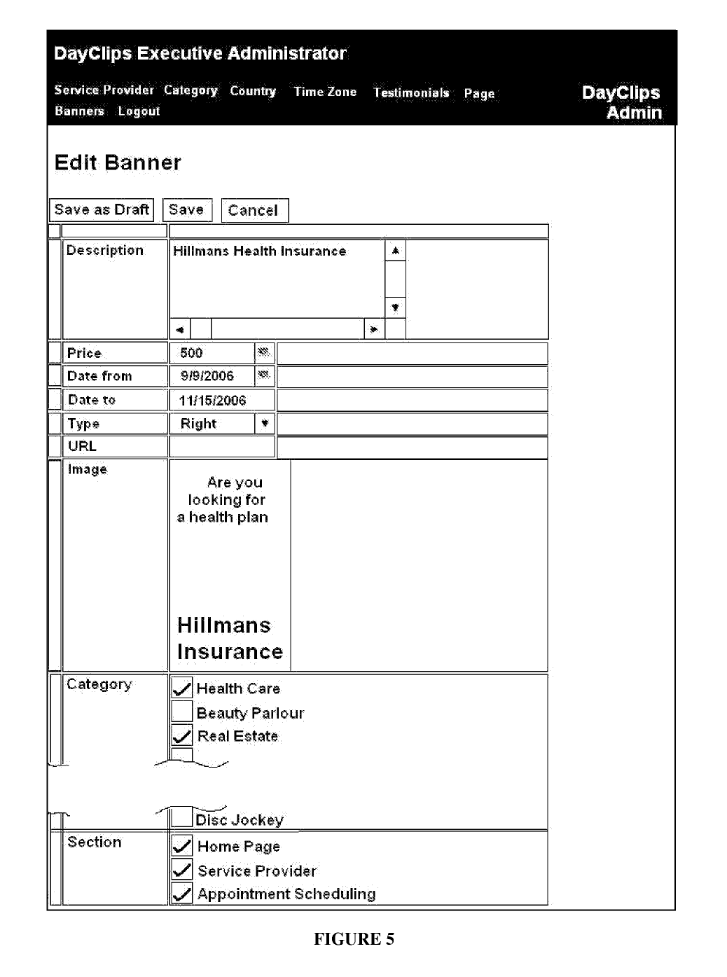

The advertisements on the host website may be selected based on the demographic information associated with a specific user 201 and expected level of interest in a product or service. The advertisers 203 may select a group of users from a list provided by the host website. For example, the advertisers 203 may advertise expensive products or services to groups of users with a high level of income. The advertisers 203 may also target advertisements to a group of users living in a specific city. Advertising on the host website may be controlled by an “Executive Administrator” web page of the host website as illustrated in FIG. 5. The advertisers 203 may edit an advertisement on the host website. The “Executive Administrator” web page allows editing of the list of service providers 202, categories of service providers 202, country and time zone of service providers 202, testimonials, default pages, and advertising banners. The advertising banners are edited and matched to the respective categories of service providers 202.

The host website may also provide electronic newsletters to the user 201 and the service providers 202. The electronic newsletters may include the targeted advertisements. Further, the host website may include links to the targeted advertisements, links for procurement of products or services, and links to external websites. For example, hyperlinks may be provided on the host website. Hyperlinks are reference links for redirecting the user 201 or the service provider from a first website to a second website or from the current document in the first website to other documents in the first website. The hyperlinks may redirect the user 201 or the service provider to a web page comprising advertisements. Further, the hyperlinks may redirect the user 201 to a promotion webpage comprising audio or visual presentations used for promotion by the service provider.

The promotion webpage may include questionnaires for the user 201. The questionnaires may be completed online on the promotion website by the user 201 and returned to the service provider by electronic transmission. Further, the hyperlinks may redirect the user 201 to a sales web portal for acquisition of products or services offered by service providers 202. The sales web portal may display merchandise or sales service. If legally permissible, the advertisers 203 may also sell their products or services through a hyperlink from their advertisement on the host website.

Hyperlinks may serve as an advertising mechanism for the service provider listed on the host website. The service provider may use the hyperlinks to web pages or audio-visual presentations for promotion purposes, offer questionnaires, market their services or goods, or sell merchandise. The service provider may also disseminate electronic documents including catalogs, laboratory results, and other forms of electronic communication to users who chose appointments with the service provider on the host website. The host website may store information of the number of visits made by the user 201 to the hyperlinks.

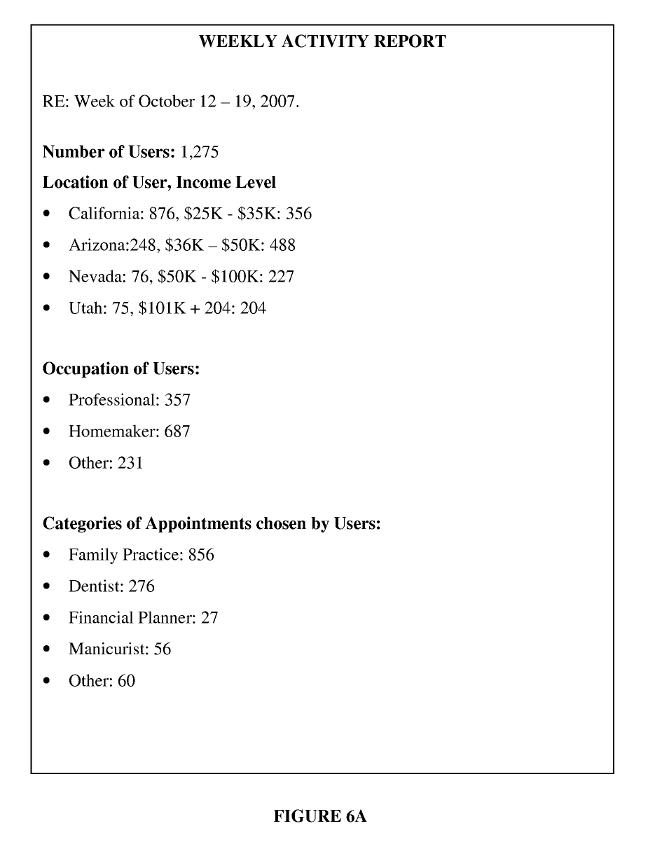

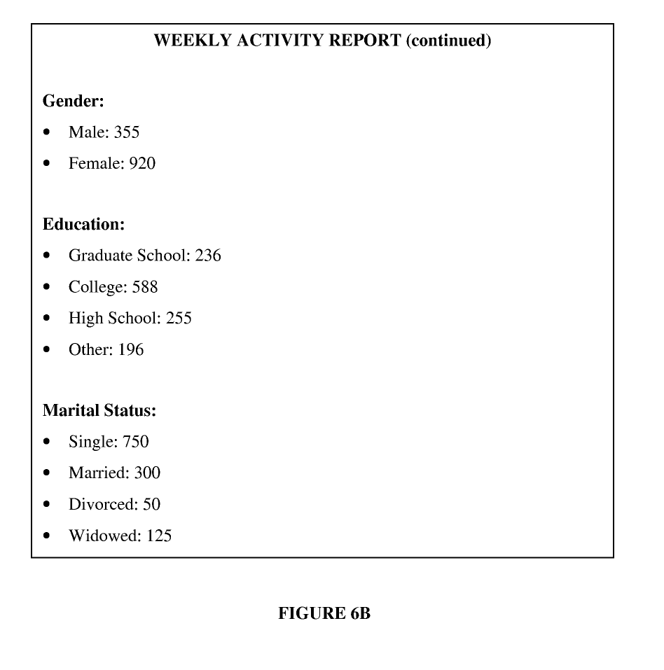

The method disclosed herein may also generate reports based on the collected demographic information and information of usage of the host website by the user 201 and the service providers 202. The reports may be generated periodically. For example, the reports may be generated on a daily, weekly, monthly, or annual basis. The information included in the reports enables the advertisers 203 to evaluate advertising strategies and thereby enhance effectiveness of their advertising strategies. The advertisers 203 compensate for usage of the host website. Compensation is based on the generated reports and the sale of products or services on the host website. FIG. 6A-6B exemplarily illustrates a report, for example, a “Weekly Activity Report” generated on the host website. The “Weekly Activity Report” provides information about the number of users, location of the users, occupation of users, gender of the users, education of the users, marital status of the users, income level of users, and category of appointments selected by the users.

The generated reports may also include custom feedback reports provided to the advertisers 203 based on their individual needs and user targets. Feedback reports provided to the advertisers 203 may include information about user referrals and resulting sales. The host website may provide the advertisers 203 with an online menu for selecting parameters for generating custom feedback reports. The generated reports may also include information of the number of visits made by the user 201 to the hyperlinks.

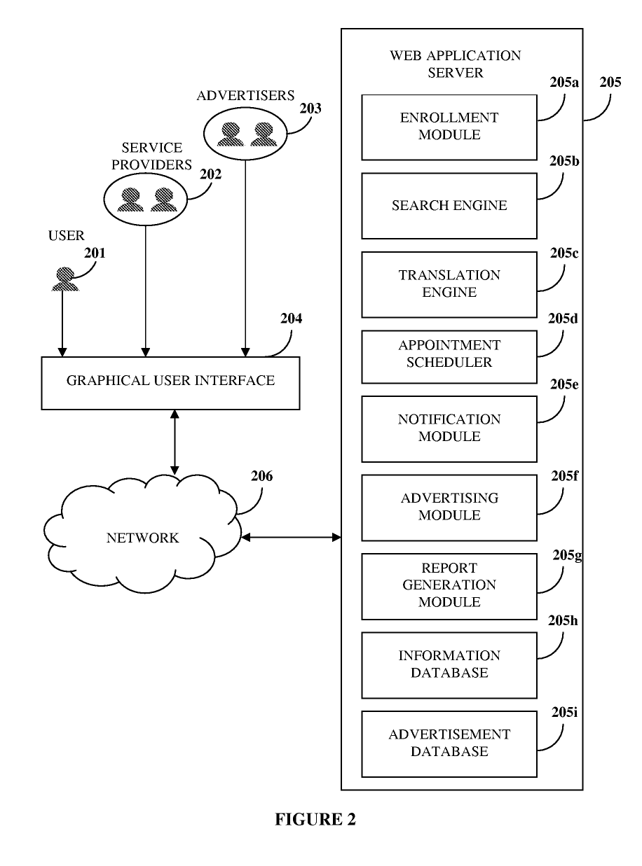

FIG. 2 illustrates a computer implemented system for integrating appointment scheduling with targeted advertising. The system disclosed herein comprises a graphical user interface (GUI) 204 and a web application server 205 connected via a network 206. The GUI 204 enables a user 201, service providers 202, and advertisers 203 to access the host website residing on the web application server 205. The web application server 205 comprises an enrollment module 205a, a search engine 205b, a translation engine 205c, an appointment scheduler 205d, a notification module 205e, an advertising module 205f, a report generation module 205g, an information database 205h, and an advertisement database 205i. The enrollment module 205a enrolls the user 201, the service providers 202, and the advertisers 203 on the host website. The user 201, the service providers 202, and the advertisers 203 create user accounts on the host website in order to enroll on the host website. The user 201 may select a service provider from a list of service providers 202 displayed on the host website. The service providers 202 may be categorized based on the type of their products or services. The user 201 may also conduct a category search and then select a service provider from the list of service providers 202 in the selected category. The search engine 205b enables the user 201 to search for a service provider on the host website.

The user 201 may make an appointment with a selected service provider through the host website or through a plurality of communication devices. The translation engine 205c translates the appointment from the communication devices by integrating the appointment made on the host website and the appointment made through the communication devices in the appointment calendar on the host website. The appointment scheduler 205d then schedules the appointment on the host website. The notification module 205e notifies the user 201 with a confirmation message upon scheduling of the appointment. The notification module 205e also notifies the user 201 and the service providers 202 with appointment reminder messages.

The advertising module 205f inserts targeted advertisements with the confirmation message and the appointment reminder messages. The advertising module 205f selects advertisements based on the demographic information associated with a specific user 201 and the expected level of interest in a product or a service. The advertising module 205f also inserts targeted advertisements with electronic newsletters provided to the user 201 and the service providers 202. The advertising module 205f may target the advertisements to the user 201 and the service providers 202 through an email attachment, fax, telephone, a text message, a voice message, or a combination thereof.

The report generation module 205g generates reports based on demographic information and information of usage of the host website by the user 201 and the service provider. The information database 205h stores user information, service provider information, advertiser information, demographic information of the user 201, generated reports, and usage information of the host website. The information may include, for example, name, mailing address, email address, phone number, services provided, etc. The information database 205h may also store information of the number of visits made by the user 201 to the hyperlinks. The advertisement database 205i stores the targeted advertisements.

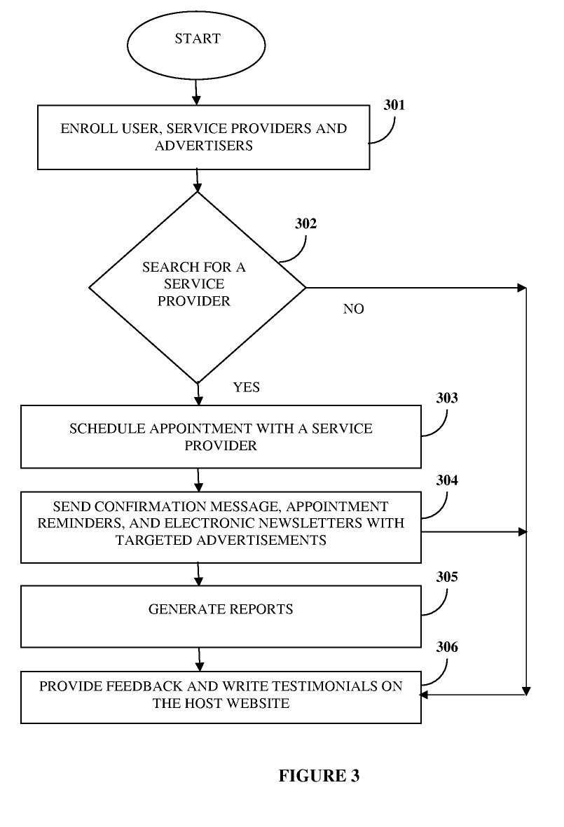

FIG. 3 exemplarily illustrates a flow chart depicting the method of integrated appointment scheduling and targeted advertising. An appointment scheduling application on a host website is used for scheduling an appointment. The user 201, the service providers 202, and the advertisers 203 enroll 301 on the host website. The user 201 searches 302 for a service provider on the host website to make an appointment with the service provider. If the user 201 does not find the requested service provider, the user 201 may perform a category search to find a suitable service provider. The user 201 may provide 306 feedback and write testimonials on the host website. If the user 201 finds a suitable service provider, then the appointment scheduling application schedules 303 the appointment between the user 201 and the service provider.

The host website sends 304 an appointment confirmation message, appointment reminder messages, and electronic newsletters with targeted advertisements to the user 201 and the service provider. The user 201 and the service provider may provide 306 feedback and may write testimonials on the host website. The host website generates 305 reports based on demographic information and the information of usage of the host website by the user 201 and the service provider. The advertisers 203 compensate for usage of the host website. Compensation is based on the generated reports and on sale of products or services on the host website. Further, the advertisers 203 may provide 306 feedback, and may write testimonials on the host website.

FIG. 4 exemplarily illustrates an appointment calendar on the host website. The host website provides a service provider with an appointment calendar. Exemplarily, the appointment calendar may be called a “Calendar of Appointments” on the host website. The appointment calendar has operating controls permitting the service provider to manually add 401a an appointment with the appointments made by online users, to change 401b existing appointments, or to delete 401c an appointment on the host website. Verbal input from a user 201 may be electronically translated to add 401a an appointment, change 401b an existing appointment, or delete 401c an appointment. For example, the user 201 may be prompted to select among choices in a telephone menu to select, change 401b, or delete 401c an appointment on the host website. A list of appointments may be displayed on the appointment calendar.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute these instructions, thereby performing one or more processes defined by these instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementing the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for implementation of processes of various embodiments.

Where databases are described such as the information database 205h and advertisement database 205i, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of integrated scheduling of an appointment and targeted advertising, comprising the steps of:
providing an appointment scheduling application on a host website;
enabling a user to search for a service provider on said host website and make said appointment with said service provider, wherein said user makes the appointment through one of the host website and a plurality of communication devices;
translating the appointment from said communication devices using said appointment scheduling application on the host website;
scheduling the appointment of the user with the service provider using the appointment scheduling application;
notifying the user with a confirmation message upon said scheduling of the appointment; and
inserting one or more of a plurality of targeted advertisements in said confirmation message;
whereby the host website enables said integrated scheduling of the appointment and said targeted advertising.

2. The computer implemented method of claim 1, wherein said step of translating comprises integrating the appointment made on the host website and the appointment made through the communication devices in an appointment calendar on the host website.

3. The computer implemented method of claim 1, further comprising a step of enrolling users, service providers, and advertisers on the host website, wherein said advertisers provide said targeted advertisements on the host website.

4. The computer implemented method of claim 1, wherein said targeted advertisements are provided to the user and the service provider.

5. The computer implemented method of claim 1, wherein said targeted advertisements include one or more of banner advertisements, pop up advertisements, and contextual advertisements.

6. The computer implemented method of claim 1, wherein advertisements are targeted to the user through one of an electronic mail attachment, fax, telephone, a text message, a voice message, and a combination thereof.

7. The computer implemented method of claim 1, further comprising a step of notifying the user and the service provider with appointment reminder messages by one of an electronic mail, fax, telephone, a text message, a voice message, and a combination thereof.

8. The computer implemented method of claim 7, wherein targeted advertisements are inserted in said appointment reminder messages.

9. The computer implemented method of claim 1, further comprising a step of providing electronic newsletters to users and service providers, wherein said electronic newsletters include one or more of said targeted advertisements.

10. The computer implemented method of claim 1, wherein the host website includes links to said targeted advertisements, links for procurement of products and services, and links to external websites.

11. The computer implemented method of claim 1, further comprising a step of generating reports based on demographic information and information of usage of the host website by the user and the service provider.

12. A computer implemented system for integrated scheduling of an appointment and targeted advertising, comprising:
a web application server, comprising:
a search engine for enabling a user to search for a service provider on a host website, wherein said user makes said appointment with said service provider through one of said host website and a plurality of communication devices;
a translation engine for translating the appointment from said communication devices;
an appointment scheduler for scheduling the appointment of the user with the service provider;
a notification module for notifying the user with a confirmation message upon said scheduling of the appointment; and
an advertising module for inserting one or more of a plurality of targeted advertisements in said confirmation message.

13. The computer implemented system of claim 12, wherein said translation engine integrates the appointment made on the host website and the appointment made through the communication devices in an appointment calendar on the host website.

14. The computer implemented system of claim 12, wherein said web application server further comprises an enrollment module for enrolling users, service providers, and advertisers on the host website, wherein said users, said service providers, and said advertisers enroll on the host website using a graphical user interface.

15. The computer implemented system of claim 12, wherein said advertising module targets advertisements to the user and the service provider.

16. The computer implemented system of claim 12, wherein said notification module notifies the user and the service provider with appointment reminder messages, wherein said appointment reminder messages are inserted with one or more of said targeted advertisements using said advertising module.

17. The computer implemented system of claim 12, wherein said web application server further comprises a report generation module for generating reports based on demographic information and information of usage of the host website by the user and the service provider.

18. The computer implemented system of claim 12, wherein said web application server further comprises an information database for storing user information, service provider information, advertiser information, demographic information, generated reports, and usage information of the host website.

19. The computer implemented system of claim 12, wherein said web application server further comprises an advertisement database for storing said targeted advertisements.

20. A computer program product comprising computer executable instructions embodied in a computer-readable medium, wherein said computer program product comprises:
a first computer parsable program code for enabling a user to search for a service provider on a host website, wherein said user makes an appointment with said service provider through one of the host website and a plurality of communication devices;
a second computer parsable program code for translating said appointment from said communication devices;
a third computer parsable program code for scheduling the appointment of the user with the service provider on the host website;
a fourth computer parsable program code for notifying the user with a confirmation message upon said scheduling of the appointment;
a fifth computer parsable program code for inserting one or more of a plurality of targeted advertisements in one of said confirmation message, appointment reminder messages, and electronic newsletters; and
a sixth computer parsable program code for generating reports based on demographic information and information of usage of the host website by the user and the service provider.
